(19) United States
(12) Patent Application Publication
(10) Pub. No.: US 2025/0323775 A1
(43) Pub. Date: Oct. 16, 2025

(54) MECHANISM FOR HANDLING PREDICTIVE BEAM CONFIGURATIONS

(71) Applicant: SHARP KABUSHIKI KAISHA, Sakai City (JP)

(72) Inventors: Rudraksh Shrivastava, Erlingheim (DE); Tomoki Yoshimura, Camas, WA (US)

(21) Appl. No.: 18/632,239

(22) Filed: Apr. 10, 2024

(51) Int. Cl. H04L 5/00

(52) U.S. Cl. CPC H04L 5/0094

(57) ABSTRACT

A user equipment (UE) that includes one or more non-transitory computer-readable media that stores computer-executable instructions for handling predictive transmission configuration indication (TCI) states and a processor is provided. The processor is configured to receive, from a base station (BS), several predicted TCI states. Each predicted TCI state corresponds to a future time instance from several time instances. The processor is configured to store the predicted TCI states. The processor is configured to select, at the occurrence of a time instance from the several time instances, a predicted stored TCI state that corresponds to the time instance. The processor is configured to indicate the predicted TCI state that corresponds to the time instance to a physical protocol stack layer of the UE.

### TECHNICAL FIELD

The technology generally relates to wireless communications, and more particularly, to predictive beam configuration.

### BACKGROUND

Because of the tremendous growth in the number of connected devices and the rapid increase in the user/network (NW) traffic volume, various efforts have been made to improve different aspects of the wireless communications in the next-generation radio communication systems, such as the 5th generation (5G) New Radio (NR). Such improvements include improving data rate, latency, reliability, mobility, etc.

The 5G NR system is designed to provide flexibility and configurability to optimize NW services and types, thus accommodating various use cases, such as enhanced Mobile Broadband (eMBB), massive Machine-Type Communication (mMTC), and Ultra-Reliable and Low-Latency Communication (URLLC).

As the demand for radio access continues to increase, however, there is a need for further improvements in wireless communications in the next-generation radio communication systems.

### SUMMARY

In a first aspect of the present application, a user equipment (UE) is provided. The UE includes one or more non-transitory computer-readable media storing one or more computer-executable instructions for handling predictive transmission configuration indication (TCI) states and at least one processor coupled to the one or more non-transitory computer-readable media. The at least one processor is configured to execute the one or more computer-executable instructions to cause the UE to receive, from a base station (BS), several predicted TCI states, each predicted TCI state in the several predicted TCI states corresponding to a future time instance in several time instances; store the several predicted TCI states; select, at an occurrence of a time instance in the several time instances, a predicted TCI state in the stored several predicted TCI states that corresponds to the time instance; and indicate the predicted TCI state corresponding to the time instance to a physical protocol stack layer of the UE.

In an implementation of the first aspect, receiving the several predicted TCI states includes receiving the several predicted TCI states through one of radio resource control (RRC) signaling, downlink control information (DCI), or medium access (MAC) control element (CE).

In another implementation of the first aspect, the time instance includes one of a time instant, a transmission time interval (TTI), a slot, or a duration of time.

In another implementation of the first aspect, the at least one processor is further configured to execute the one or more computer-executable instructions to cause the UE to receive downlink (DL) data from the BS using one or more resources identified by the predicted TCI state indicated to the physical protocol layer.

In another implementation of the first aspect, the DL data includes one of a physical downlink control channel (PDCCH) or a physical downlink shared channel (PDSCH).

In another implementation of the first aspect, each predicted TCI state in the several predicted TCI states represents a specific beam configuration.

In another implementation of the first aspect, the several predicted TCI states is generated by one of the BS or the UE using one or more artificial intelligence/machine learning (AI/ML) mechanisms.

In a second aspect of the present application, a UE is provided. The UE includes one or more non-transitory computer-readable media storing one or more computer-executable instructions receiving several TCI states from a BS and at least one processor coupled to the one or more non-transitory computer-readable media. The at least one processor is configured to execute the one or more computer-executable instructions to cause the UE to receive, from the BS, a configuration that includes several TCI states, the configuration identifying each TCI state as one of an actual TCI state corresponding to a current time instance in several time instances or a predictive TCI state corresponding to a future time instance in the several time instances; store the several TCI states; select, at an occurrence of a time instance in the several time instances, a TCI state in the stored several TCI states corresponding to the time instance; and indicate the TCI state corresponding to the time instance to a physical protocol stack layer of the UE.

In an implementation of the second aspect, the TCI state corresponding to the time instance is a predictive TCI state.

In another implementation of the second aspect, the TCI state corresponding to the time instance is an actual TCI state.

In another implementation of the second aspect, the configuration further identifies each TCI state as an activated TCI state or a deactivated TCI state.

In another implementation of the second aspect receiving the configuration includes receiving the configuration through one of RRC signaling, DCI, or MAC CE.

In another implementation of the second aspect, the at least one processor is further configured to execute the one or more computer-executable instructions to cause the UE to receive DL data from the BS using one or more resources identified by the TCI state indicated to the physical protocol layer.

In another implementation of the second aspect, the several predicted TCI states is generated by one of the BS or the UE using one or more AI/ML mechanisms.

In a third aspect, a method of handling TCI states is provided. The method includes receiving, from a BS, several predicted TCI states, each predicted TCI state in the several predicted TCI states corresponding to a future time instance in several time instances; storing the several predicted TCI states; selecting, at an occurrence of a time instance in several time instances, a predicted TCI state in the stored several predicted TCI states that corresponds to the time instance; and indicating the predicted TCI state corresponding to the time instance to a physical protocol stack layer of the UE.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a schematic diagram illustrating an example radio communication system, according to an example implementation of the present disclosure.

FIG. 2 is a sequence diagram illustrating an example message flow for handling predictive beam configurations, according to an example implementation of the present disclosure.

FIG. 3 is a flowchart illustrating an example method/process performed by a UE for handling predictive beam configurations, according to an example implementation of the present disclosure.

FIG. 4 is a sequence diagram illustrating an example message flow for handling a mix of predictive beam configurations and actual/measured beam configurations, according to an example implementation of the present disclosure.

FIG. 5 is a flowchart illustrating an example method/process performed by a UE for handling a mix of predictive and actual/measured beam configurations, according to an example implementation of the present disclosure.

FIG. 6 is a sequence diagram illustrating an example message flow for measuring the quality of beams that are associated with predictive beam configurations, according to an example implementation of the present disclosure.

FIG. 7 is a flowchart illustrating an example method/process performed by a UE for measuring the quality of beams that are associated with predictive beam configurations, according to an example implementation of the present disclosure.

FIG. 8 is a sequence diagram illustrating an example message flow for measuring the quality of beams that are associated with predictive beam configurations, according to an example implementation of the present disclosure.

FIG. 9 is a flowchart illustrating an example method/process performed by a UE for measuring the quality of beams that are associated with predictive beam configurations based on the quality of one or more reference beams, according to an example implementation of the present disclosure.

FIG. 10 is a timing diagram illustrating an example representation of the UE and the BS interactions, according to an example implementation of the present disclosure.

FIG. 11 is a block diagram illustrating a node for wireless communication, according to an example implementation of the present disclosure.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not shown) by the same numerals in the example figures. However, the features in different implementations may differ in other respects, and thus may not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent. In addition, the terms “system” and “network” herein may be used interchangeably.

As used herein, the term “and/or” should be interpreted to mean one or more items. For example, the phrase “A, B, and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B, and C” or the phrase “at least one of A, B, or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C.

Additionally, for the purposes of explanation and non-limitation, specific details, such as functional entities, techniques, protocols, standard, and the like are set forth for providing an understanding of the described technology. In other examples, detailed descriptions of well-known methods, technologies, systems, architectures, and the like are omitted so as not to obscure the description with unnecessary details.

Persons skilled in the art will immediately recognize that any network function(s) or algorithm(s) described in the present disclosure may be implemented by hardware, software, or a combination of software and hardware. Described functions or algorithms may correspond to modules which may be software, hardware, firmware, or any combination thereof. The software implementation may include computer executable instructions stored on a computer-readable medium, such as a memory or other types of storage devices. For example, one or more microprocessors or general-purpose computers with communication processing capability may be programmed with corresponding executable instructions and carry out the described network function(s) or algorithm(s). The microprocessors or general-purpose computers may include of one or more Application-Specific Integrated Circuits (ASICs), programmable logic arrays, and/or one or more Digital Signal Processor (DSPs). Although some of the example implementations described in this specification are oriented to software installed and executing on computer hardware, nevertheless, alternative example implementations implemented as firmware, as hardware, or as a combination of hardware and software are well within the scope of the present disclosure.

The computer-readable medium includes, but is not limited to, Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture (e.g., a Long-Term Evolution (LTE) system, an LTE-Advanced (LTE-A) system, an LTE-Advanced Pro system, or a 5G NR Radio Access Network (RAN)) typically includes at least one base station (BS), at least one UE, and one or more optional network elements that provide connection towards a network. The UE communicates with the network (e.g., a Core Network (CN), an Evolved Packet Core (EPC) network, an Evolved Universal Terrestrial Radio Access network (E-UTRAN), a 5G Core (5GC), or an internet), through a radio communication network established by one or more BSs.

It should be noted that, in the present disclosure, a UE (or a terminal device) may include, but is not limited to, a mobile station, a mobile terminal or device, a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A BS may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GPRS), Universal Mobile Telecommunication System (UMTS, often referred to as 3G) based on basic wideband-code division multiple access (W-CDMA), high-speed packet access (HSPA), LTE, LTE-A, evolved LTE (ELTE), for example, LTE connected to 5GC, NR (often referred to as 5G), and/or LTE-A Pro. However, the scope of the present disclosure should not be limited to the above-mentioned protocols.

A BS may include, but is not limited to, a node B (NB) as in the UMTS, an evolved node B (eNB) as in the LTE or LTE-A, a radio network controller (RNC) as in the UMTS, a base station controller (BSC) as in the GSM/GSM Enhanced Data rates for GSM Evolution (EDGE) Radio Access Network (GERAN), a next-generation eNB (ng-eNB) as in an Evolved Universal Terrestrial Radio Access (E-UTRA) BS in connection with the 5GC, a next-generation Node B (gNB) as in the 5G Access Network (5G-AN), and any other apparatus capable of controlling radio communication and managing radio resources within a cell. The BS may connect to serve the one or more UEs through a radio interface to the network.

The BS may be operable to provide radio coverage to a specific geographical area using several cells included in the radio communication network. The BS may support the operations of the cells. Each cell may be operable to provide services to at least one UE within its radio coverage. Specifically, each cell (often referred to as a serving cell) may provide services to serve one or more UEs within its radio coverage (e.g., each cell may correspond to the Downlink (DL) and optionally Uplink (UL) resources to at least one UE within its radio coverage for DL and optionally UL packet transmission). The BS may communicate with one or more UEs in the radio communication system through the cells.

A cell may correspond to sidelink (SL) resources for supporting Proximity Service (ProSe) or Vehicle to Everything (V2X) services. Each cell may have overlapped coverage areas with other cells.

As discussed above, the frame structure for NR is to support flexible configurations for accommodating various next generation (e.g., 5G) communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in the 3^{rd} Generation Partnership Project (3GPP) may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it should also be noted that in a transmission time interval (TTI) of a single NR frame, DL transmission period, a guard period, and UL transmission data may at least be included, where the respective portions of the DL transmission data, the guard period, and the UL transmission data should also be configurable, for example, based on the network dynamics of NR. In addition, sidelink resources may also be provided in an NR frame to support ProSe services, (E-UTRA/NR) sidelink services, or (E-UTRA/NR) V2X services.

A UE configured with multi-connectivity may connect to a Master Node (MN) as an anchor and one or more Secondary Nodes (SNs) for data delivery. Each one of these nodes may be formed by a cell group that includes one or more cells. For example, a Master Cell Group (MCG) may be formed by an MN, and a Secondary Cell Group (SCG) may be formed by an SN. In other words, for a UE configured with dual connectivity (DC), the MCG may be a set of one or more serving cells including the PCell and zero or more secondary cells. Conversely, the SCG may be a set of one or more serving cells including the PSCell and zero or more secondary cells.

As also described above, the Primary Cell (PCell) may be an MCG cell that operates on the primary frequency, in which the UE either performs the initial connection establishment procedure or initiates the connection reestablishment procedure. In the DC mode, the PCell may belong to the MN. The Primary SCG Cell (PSCell) may be an SCG cell in which the UE performs random access (e.g., when performing the reconfiguration with a sync procedure). In Multi-RAT Dual Connectivity (MR-DC), the PSCell may belong to the SN. A Special Cell (SpCell) may be referred to a PCell of the MCG, or a PSCell of the SCG, depending on whether the Medium Access Control (MAC) entity is associated with the MCG or the SCG. Otherwise, the term Special Cell may refer to the PCell. A Special Cell may support a Physical Uplink Control Channel (PUCCH) transmission and contention-based Random Access, and may always be activated. Additionally, for a UE in an RRC_CONNECTED state that is not configured with the carrier aggregation/dual connectivity (CA/DC), may communicate with only one serving cell (SCell) which may be the primary cell. Conversely, for a UE in the RRC_CONNECTED state that is configured with the CA/DC a set of serving cells including the special cell(s) and all of the secondary cells may communicate with the UE.

According to one aspect of the present embodiment, a waveform formed based on the OFDM may be used in a radio communication system. An OFDM symbol defines a unit in the time domain of the waveform. Each OFDM symbol is converted to a time-continuous signal during a baseband signal generation. For example, the cyclic prefix-OFDM (CP-OFDM) may be used in the downlink transmission of the radio communication system. For example, either CP-OFDM or Discrete Fourier Transform-spread-Orthogonal Frequency Division Multiplex (DFT-s-OFDM) may be used in the uplink transmission of the radio communication system.

It should be noted that the term transmission reception point (TRP) in the present disclosure may be replaced by ‘beam’ or ‘panel’. It should also be noted that the term ‘overlap’ may refer to time domain overlapping or frequency domain overlapping.

Examples of some selected terms in the present disclosure are provided as follows.

Antenna Panel: It may be assumed that an antenna panel is an operational unit for controlling a transmit spatial filter/beam. An antenna panel typically includes several antenna elements. A beam can be formed by an antenna panel and in order to form two beams simultaneously, two antenna panels are needed. Such simultaneous beamforming from multiple antenna panels is subject to the UE capability. A similar definition for “antenna panel” may be possible by applying spatial receiving filtering characteristics.

BWP: A subset of the total cell bandwidth of a cell is referred to as a bandwidth part (BWP), and bandwidth adaptation (BA) is achieved by configuring the UE with BWP(s) and telling the UE which of the configured BWPs is currently the active one. To enable BA on the PCell, the gNB configures the UE with UL and DL BWP(s). To enable BA on the SCells in case of the CA, the gNB configures the UE at least with the DL BWP(s) (e.g., there may be no BWP in the UL). For the PCell, the initial BWP is the BWP used for an initial access. For the SCell(s), the initial BWP is the BWP configured for the UE to first operate at the SCell activation. The UE may be configured with a first active uplink BWP, for example, by a firstActiveUplinkBWP IE. If the first active uplink BWP is configured for an SpCell, the firstActiveUplinkBWP information element (IE) field may contain the ID of the UL BWP to be activated upon performing the RRC (re-) configuration. If the firstActiveUplinkBWP IE field is absent, the RRC (re-) configuration may not impose a BWP switch. If the first active uplink BWP is configured for an SCell, the firstActiveUplinkBWP IE field may contain the ID of the UL BWP to be used upon the MAC-activation of an SCell.

TCI state: A transmission configuration indication (TCI) state may contain parameters for configuring a Quasi-CoLocation (QCL) relationship between one or more reference signals and a target reference signal set. For example, a target reference signal set may be the Demodulation Reference Signal (DM-RS) ports of the Physical Downlink Shared Channel (PDSCH), Physical Downlink Control Channel (PDCCH), PUCCH or Physical Uplink Shared Channel (PUSCH). The one or more reference signals may include UL or DL reference signals. In NR Rel-15/16, the TCI state is used for DL QCL indication whereas spatial relation information is used for providing UL spatial transmission filter information for UL signal(s) or UL channel(s). Here, a TCI state may refer to information provided similar to spatial relation information, which could be used for UL transmission. In other words, from the UL perspective, a TCI state provides a UL beam information which may provide the information for a relationship between a UL transmission and a DL (or a UL) reference signal (e.g., Channel State Information Reference Signal (CSI-RS), Synchronization Signal Block (SSB), Sounding Reference Signal (SRS), Phase Tracking Reference signal (PTRS)).

A UE may be configured with a list including up to M TCI state configurations, where each TCI state may contain parameters for configuring at least one QCL relationship between one or more downlink reference signals and the DM-RS ports of the PDSCH, the DM-RS port of PDCCH, or the CSI-RS port(s) of a CSI-RS resource. The QCL types corresponding to each DL RS may be given, for example, by the higher layer (e.g., RRC layer), parameters for the at least one RS and may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial reception (Rx) parameter}

Furthermore, a UE may be configured with a TCI state configuration that contains parameters for determining a UL transmission (TX) spatial filter for the UL transmissions. More specifically, when signals transmitted from different antenna ports share channels with similar properties, the antenna ports are said to be QCL signals. Basically, the QCL concept is introduced to help the UE with a precise channel estimation, frequency offset error estimation, and synchronization procedures.

Panel: The UE panel information may be derived from the TCI state/UL beam indication information or from the network signaling.

Beam: The term “beam” may be replaced with spatial filter. For example, when a UE reports a preferred gNB TX beam, the UE is essentially selecting a spatial filter used by the gNB. The term “beam information” may be used to provide information about which beam/spatial filter has been used/selected.

Multi-TRP: Multi-TRP is a feature that enables a BS (e.g., a gNB) to communicate with a UE using more than one TRP, for example, to ensure reliability. Moreover, NR supports same data stream(s) received from multiple TRPs at least with an ideal backhaul, and different NR-PDSCH data streams received from multiple TRPs with both ideal and non-ideal backhauls. An ideal backhaul may allow single Downlink Control Information (DCI) to be transmitted via a PDCCH from one TRP to schedule data transmission (or information) to/from multiple TRPs (may also be referred to as single-DCI based multi-TRP/panel transmission). On the other hand, a non-ideal backhaul may require multiple DCIs to be carried in the PDCCH(s) to schedule data transmission (or information) corresponding to each TRP (may also be referred to as multi-DCI based multi-TRP/panel transmission). To enhance reliability for the system, at least one multi-TRP scheme may be applied to at least one channel/reference signal, for example, a multi-TRP based PDSCH operation, a multi-TRP based PDCCH operation, a multi-TRP based PUCCH operation, and/or a multi-TRP based PUSCH operation.

TDM based PDCCH repetition: For example, two PDCCHs may be linked together for the repetition of the same DCI format, the same DCI payload, the same number of CCEs, and/or the same number of candidates for each AL. The two PDCCHs may be in two search spaces associated with two Control Resource Sets (CORESETs).

TDM based PDSCH repetition: PDSCH repetition refers to multiple PDSCHs that have the same TB and are associated with different TRPs. Slot-based PDSCH repetition corresponds to scheduling each repetitive PDSCH in individual slots. Non-slot-based PDSCH repetition corresponds to scheduling multiple repetitive PDSCHs within the same slot.

TDM based PUCCH repetition: PUCCH repetition refers to multiple PUCCHs with the same Uplink Control Information (UCI) content but corresponding to different beams. There are two types of PUCCH repetitions: inter-slot based PUCCH repetition and intra-slot based PUCCH repetition, which are categorized according to their timing and relate to all PUCCH formats. Inter-slot based PUCCH transmission corresponds to transmitting each repetitive PUCCH in individual slots. Intra-slot based PUCCH transmission corresponds to transmitting each repetitive PUCCH in individual slots and transmitting multiple repetitive PDSCHs within the same slot.

TDM based PUSCH repetition: PUSCH repetition refers to multiple PUSCHs with the same TB but corresponding to different TRPs. Slot-based PUSCH repetition corresponds to scheduling each repetitive PUSCH in an individual slot. Non-slot-based PUSCH repetition corresponds to scheduling multiple repetitive PUSCHs within the same slot.

Frequency Division Multiplexing (FDM) based PDSCH repetition: Multiple PDSCHs with the same TB but corresponding to two TCI states. These PDSCHs are allocated to non-overlapping frequency resources within a slot.

Multi-DCI based PDSCH scheme: Two PDCCHs from separate search spaces associated with different CORESET pool indexes that schedule the corresponding PDSCHs.

Single Frequency Network (SFN) based PDCCH scheme: A CORESET is associated with two different beams.

SFN based PDSCH scheme: A PDSCH is associated with two different beams.

Unified TCI framework: To facilitate more efficient (lower latency and overhead) DL/UL beam management to support a larger number of configured TCI states, a unified TCI framework for beam indication may result in some benefits of low complexity and simplified controlling mechanisms. More specifically, through the unified indication, the DL or UL channels/signals may share the same indicated TCI state to reduce the signaling overhead, and different channels and/or reference signals may share similar channel properties. The unified indication may be used to indicate a common TCI state for the DL channels (e.g., including a PDCCH, PDSCH, and/or DL reference signal), a common TCI state for the UL channels (e.g., including a PUCCH, PUSCH, and/or UL reference signal), and/or a common TCI state for both DL and UL channels. The unified indication for a common TCI state for the DL channels may be referred to as a “DL TCI state” or a “DL only”. The unified indication for a common TCI state for the UL channels may be referred to as a “UL TCI state” or a “UL only”. The unified indication for a common TCI state for both DL and UL channels may be referred to as a “joint TCI state” or a “joint indication”. The “DL only” and “UL only” may also be referred to as a “separate TCI state,” as opposed to the “joint TCI state”.

Unified TCI states may be indicated through an RRC message, a Medium Access Control Element (MAC CE), and/or the DCI. For example, the RRC message may indicate whether the unified framework is enabled. The MAC CE may further indicate where to apply the unified TCI framework. In addition, the DCI may also include information for the unified TCI states to explicitly indicate the TCI states to the UE. In particular, the information contained in the MAC CE may refer to a serving cell index, a DL BWP index, a UL BWP index, the number of TCI states included in each TCI codepoint, transmission direction, and/or a TCI state index. However, when the unified TCI framework is applied to multiple TRPs, there is no further information to link the specific TCI states to the specific TRPs. Consequently, since multiple TRPs may correspond to different schemes, such as a TDM scheme, an FDM scheme, a multi-DCI scheme, and an SFN scheme, some potential impact may need to be considered when applying the unified TCI framework (e.g., including the DL only, UL only, and/or joint indication) to different schemes for multiple TRPs. The following cases are listed as possible scenarios where the unified TCI framework may be applied. Furthermore, the listed scenarios may correspond to an intra-cell or an inter-cell multi-TRP scheme. It should be noted that the disclosed implementations may include one or more of the following scenarios:
Single DCI based TDM PDSCH repetition;
Single DCI based FDM PDSCH repetition;
Multi-DCI based PDSCH;
TDM PDCCH repetition;
FDM PDCCH repetition;
Single DCI based TDM PUSCH repetition;
TDM PUCCH repetition;
SFN based PDCCH scheme;
SFN based PDSCH scheme;
Single DCI based FDM PUSCH repetition;
Multi-DCI based PUSCH;
FDM PUCCH repetition;
SFN based PUSCH scheme; and
SFN based PUCCH scheme.

When the unified TCI framework is applied to at least one multi-TRP scheme, some changes may be needed. The changes may include the association between the unified indication and at least one TRP, the mapping order of the indicated TCI states, the association between the unified indication and the respective channel, and/or the method of signaling for each channel. In the present disclosure, implementations for applying the unified TCI framework to the multi-TRP scheme are disclosed hereinafter.

The 3GPP (e.g., as indicated in Release 18, study item (SI) on artificial intelligence/machine learning (AI/ML) for air interface) has identified the following scopes: (i) identify use cases and scenarios where the AI/ML may be effectively applied within the 3GPP-defined network architectures and protocols, (ii) study the integration of the AI/ML algorithms into the network functions, protocols, and management systems to enable intelligent decision-making and automation, and (iii) evaluate the impact of the AI/ML on the network scalability, reliability, energy efficiency, spectral efficiency, and quality of service.

For an AI/ML based beam management (BM) use case, the following two use cases may be selected as the representative AI/ML sub-use cases. The first use case (BM-Case1) may be for spatial-domain downlink beam prediction for a first set of beams (e.g., Set A of beams) based on measurement results of a second set of beams (e.g., Set B of beams).

For the BM-Case1, the following alternatives may be considered. The AI/ML model training and inference may be done either at the NW side or at the UE side. Set A and Set B may be different (e.g., Set B may not be a subset of Set A) or Set B may be a subset of Set A. It should be noted that Set A is for DL beam prediction. The codebook construction of Set A and Set B may be later defined.

The AI/ML model input may consider the following alternatives: (1) The layer 1 reference signal reception power (L1-RSRP) measurement based on Set B, the L1-RSRP measurement based on Set B and assistance information, the channel impulse response (CIR) based on Set B, or the L1-RSRP measurement based on Set B and the corresponding DL Tx and/or reception (Rx) beam ID.

The second use case (BM-Case2) may be for temporal downlink beam prediction for Set A of beams based on the historic measurement results of Set B of beams. For the BM-Case2, the following alternatives may be considered. The AI/ML model training and inference may be done either at the NW side or at the UE side. Set A and Set B of beams may be different (e.g., Set B may not be a subset of Set A), Set B may be a subset of Set A (e.g., Set A and Set B may not be the same), or Set A and Set B are the same.

The AI/ML model input may consider measurement results of K (K≥1) latest measurement instances with the following alternatives: (1) Only the L1-RSRP measurements based on Set B, (2) The L1-RSRP measurements based on Set B and assistance information, or (3) The L1-RSRP measurements based on Set B and the corresponding DL Tx and/or Rx beam identification (ID). F predictions for F future time instances may be obtained based on the output of the AI/ML model, where each prediction is for each time instance. F may, at least be equal to 1.

Based on the current implementation of the 3GPP, management of the beam prediction information, and configuration of the same to the UEs are not described. In addition, the UE and network behaviors are not specified in a case where the AI/ML beam prediction information is not accurate or does not match the actual beam measurements by the UE. Present disclosure provides mechanisms for the management and configuration of the (AI/ML) beam prediction information, as well as, for detection and reporting of inaccuracies in the (AI/ML) beam prediction information.

Several examples of the present embodiments are described using, for example, the Beam Management Case 2, as described above. In these embodiments, beam prediction using the AI/ML model may be performed at the UE side or at the network side using, for example, parameters like the actual or predicted L1-RSRP or using historic measurements of the beams, and/or any other AI/ML mechanisms. The present embodiments address the issues related to beam prediction information and related parameters, the application of beam prediction related parameters and its configuration procedure to the UE(s), the UE's behavior when an actual beam is detected and how it maps to the beam prediction configuration provided, in advance, by the network. The present embodiments address the failure scenarios by defining the UE's and network's behavior when the network configured beam prediction configuration is not accurate and does not match the actual beam measurements by the UE.

Based on the parameters like report of the predicted top-K beam IDs, report of the predicted and/or actual/measured L1-RSRPs associated with the predicted top-K beams, report of the quantities indicating the confidence level of predictions for the top-K beams (e.g., the standard deviation of the predicted L1-RSRPs or statistics of the past RSRP measurements as a proxy for the confidence level of the predictions) and other related parameters like KPI, the AI/ML model may provide output in the form of F (f1, f2 . . . fn) predictions for T (t1, t2, . . . tn) future time instances. The prediction may reflect predicted beams and their corresponding configurations.

RAN work group 1 (RAN WG1 or RAN1) Agreement 116 has agreed that beam indication for the NW-sided model and for the UE-sided model is based on the unified TCI state framework. However, whether any enhancements are needed and how the potential enhancements are implemented are left for further study (FFS).

The RAN1 Agreement 116 has also identified the predicted beam indication and the followings aspects for further study: (i) the indication of the predicted beam in Set A, (ii) whether the predicted beam is associated with RS resource for Set B of beams, (iii) whether, and how, to extend the timeline methodologies for unknown TCI states for the predicted beam indication, (iv) beam indication of multiple future time instances, and (v) whether the beam indication is based on the unified TCI state framework.

As per the existing 3GPP specifications, the MAC behavior for the TCI states activation or deactivation is only specified for the actual or measured beam(s) and not for the future predicted beams using the AI/ML models. When the UE detects a beam and receives a MAC CE from the network, the UE may act as follows. When the MAC entity receives the MAC CE for a Serving Cell, the MAC CE indicates the information regarding the TCI states activation or deactivation to the lower layers. The MAC CE allows the network to activate or deactivate specific TCI states for the UE-specific PDSCH transmission.

This procedure allows the network to control the activation and deactivation of the TCI states for the PDSCH transmission, providing flexibility and optimization in resource allocation and beamforming strategies. The MAC entity plays a crucial role in communicating these commands to the lower layers to ensure proper configuration and operation of the physical layer transmission. Hence, considering this behavior and the RAN 1 agreements and discussions, currently the UE or MAC behavior is not defined in the standards when the UE receives beam indication and the TCI state information of multiple future time instances in single or multiple messages/commands.

### Beam Pair Selection Process

There may be three distinct DL processes of operations to obtain the best beam pair selection. These processes are colloquially referred to as P1, P2 and P3 in technical discussions and reports.

P1 is the initial process dedicated to the BS (e.g., gNB) beam selection. In P1, broad beams are typically used to sweep the angular space and a coarse serving direction may be chosen based on measurements from a broad-beam UE. P1 may be used to enable the UE measurement on different TRP Tx beams to support selection of the TRP Tx beams/UE Rx beam(s). Beamforming at the TRP, may typically include an intra/inter-TRP Tx beam sweep from a set of different beams. Beamforming at the UE may typically include a UE Rx beam sweep from a set of different beams. Before a data flow is enabled in the scheduler, periodic SSB beam scanning may be implemented on the BS side in a certain intervals (the SSB periodicity). At the same time, wide beam scanning may be implemented on the UE side to determine the optimal receive wide beam (the Optimal SSB/Physical Random Access Channel (SSB/PRACH) beams).

P2 is the second process to refine P1's beam selection using narrower BS beams. P2 may still employ a broad beam at the UE. P2 may be used to enable the UE measurements on different TRP Tx beams to possibly change the inter/intra-TRP Tx beam(s). P2 may use a possibly smaller set of beams for beam refinement than P1. It should be noted that that P2 may be a special case of P1, for example, by performing a beam sweep in a narrower angular sector than in P1. The narrow beams closest to the wide beam in the beam grid may be selected to be examined using CSI-RS (followed by CSI-report).

P3 is the final process of beam alignment for the UEs equipped to support beamforming. After beam selection at the BS side, the transmit beam may be fixed so the UE may refine its broad beam by sweeping through its own narrow beams. P3 may be used to enable the UE measurements on the same TRP Tx beam to change the UE Rx beam in the case the UE uses beamforming.

The optimal narrow beam may be selected from P2, and the CSI-RSs may be transmitted to the UE. The UE may update its Rx beam. In the data transmission, the BS may use the best BS Tx beam found during P2 and the UE may use the best UE Rx beam found during P3.

It should be noted that, while data transmission is being performed on an active beam pair link, the UE may monitor the PDCCH on another beam pair as a backup link for swift fallback if there is a sudden blockage of the active link.

### Synchronization Signal Blocks

The Synchronization Signal/Physical Broadcast Channel (SS/PBCH) Blocks, typically shortened to SSBs, are a pivotal part of the NR. The SSBs may be broadcast periodically for the UE's measurement purposes. A single SSB, spanning 4 OFDM symbols in time and 240 subcarriers in frequency, may include both synchronization signals and broadcast channels. The Primary Synchronization Signal (PSS) and the Secondary Synchronization Signal (SSS) may be carried in the SSB as two 127-long pseudo random binary m-sequences employed for initial synchronization and cell identification. The PBCH associated with the Demodulation Reference Signal (DMRS) may contain system control information that the UE may require to communicate with the network.

During the beam sweeping procedure, the SSBs may be transmitted in groups, known as SSBursts, according to a numerology-dependent transmission pattern. In Frequency Range 2 (FR2), an SSBurst may contain up to 64 SSBs. Each SSB may be mapped to a unique BS beam so that the UE may decode it, measure that beam's power level, and report the beam's L1-RSRP value back to the BS for beam determination. This may be done through SS-RSRP, which may be defined as the linear average over the power contributions in Watt of the resource elements that carry an SSS. For beam acquisition, SSBs are usually employed during P1, where broader beams are considered.

The CSI-RSs are UE-specific signals transmitted by the BS to monitor the DL radio channel conditions. These NR signals are extremely flexible, allowing for 18 different time-frequency allocation configurations tailored to a multitude of applications, such as, Channel State Information (CSI) acquisition, radio resource management (RRM), or beam management. For beam management, the CSI-RS may only be configured through three distinct configurations to be used, similarly to SSBs, in L1-RSRP measurements for beam candidate selection. This may be achieved using the CSI-RSRP, which is the linear average over the power contributions in Watt of the resource elements of the antenna port(s) that carry CSI-RS configured for RSRP measurements within the considered measurement frequency bandwidth in the configured CSI-RS occasions.

In the context of beam acquisition, the CSI-RSs are associated with narrower beams and, therefore, are employed in both P2 and P3, as described above. However, their configurations differ in a higher layer parameter named “repetition,” which displays a binary “on” or “off” state. The repetition parameter may only be set for the CSI-RSs that are configured for the L1-RSRP and it may let the UE make a determination regarding the DL beamforming configuration on the BS side. In P2, the repetition parameter may be set to “off,” entailing that the beamforming applied to each CSI-RS resource at the BS may vary. Therefore, the UE may take that information as an indication to maintain the same spatial filtering until P2 is complete. In P3, however, the repetition parameter may be set to “on,” which means that the UE may assume that no beam sweeping is performed on the BS side and, therefore, the UE is free to sweep through its own beams for the purpose of beam refinement.

MAC CE messages may be utilized by the network to convey control information to the UE. In the context of TCI state indication, the MAC CE messages include fields that specify the activation or deactivation status of TCI states for reception of PDCCH and PDSCH. The MAC CE message includes information that corresponds to the codepoint table, indicating which TCI states should be activated or deactivated for a specific transmission. Upon receiving the MAC CE message, the UE interprets the MAC CE information and adjusts the UE's reception parameters accordingly. For example, the UE may activate or deactivate the specified TCI states as instructed by the network.

The process by which the network can activate and deactivate Transmission Combining/Beamforming (e.g., TCI) states for PDSCH transmission on a serving cell or a set of serving cells is defined in the 3GPP specification TS 38.321. The activation and deactivation are achieved through specific CEs that are exchanged between the UE's MAC entity and the lower layers.

The TCI states activation and deactivation for UE-specific PDSCH MAC CE is described in Clause 6.1.3.14 of the 3GPP specification TS 38.321 as follows. When the MAC entity receives this CE for a serving cell, it indicates the information regarding the TCI states activation or deactivation to the lower layers. This CE allows the network to activate or deactivate specific TCI states for UE-specific PDSCH transmission.

The enhanced TCI states activation and deactivation for UE-specific PDSCH MAC CE described in Clause 6.1.3.24 as follows. Similar to the previous CE, when the MAC entity receives this CE for a Serving Cell, it indicates the information regarding the enhanced TCI states activation or deactivation to the lower layers. This CE provides enhanced capabilities for activating or deactivating TCI states for UE-specific PDSCH transmission, possibly offering additional functionalities or optimizations compared to the standard activation/deactivation procedure.

This procedure allows the network to control the activation and deactivation of TCI states for PDSCH transmission and provide flexibility and optimization in resource allocation and beamforming strategies. The MAC entity plays a crucial role in communicating these commands to the lower layers to ensure proper configuration and operation of the physical layer transmission.

If there is a TCI state with TCI-Stateld i as specified in the 3GPP specification TS 38.331, this field indicates the activation/deactivation status of the TCI state with TCI-Stateld i. If this field is not indicated, the MAC entity ignores the Ti field. As per the 3GPP specification TS 38.331, the Ti field is set to 1 to indicate that the TCI state with TCI-Stateld i shall be activated and mapped to the codepoint of the DCI Transmission Configuration Indication field (as specified in the 3GPP specification TS 38.214). Alternatively, the Ti field is set to 0 to indicate that the TCI state with TCI-Stateld i shall be deactivated and is not mapped to the codepoint of the DCI Transmission Configuration Indication field. The codepoint to which the TCI State is mapped is determined by its ordinal position among all TCI States with Ti field set to 1. For example, the first TCI State with Ti field set to 1 shall be mapped to the codepoint value 0, the second TCI State with Ti field set to 1 shall be mapped to the codepoint value 1, etc. In the 3GPP specification TS 38.331, the maximum number of activated TCI states is 8. The activated TCI states may be associated with at most one Physical Cell Identity (PCI) different from the serving cell PCI at a time.

Considering the above MAC behavior, some embodiments provide a novel solution that describe how the MAC behavior changes when the TCI states of multiple future time instances are indicated to the UE using a single indication.

MAC Behavior when the TCI States of Multiple Future Time Instance are Indicated to the UE

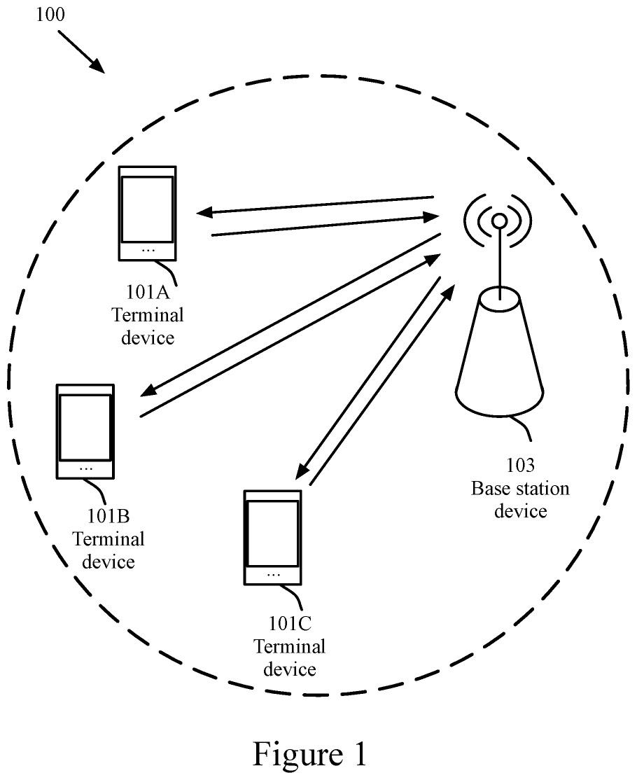

FIG. 1 is a schematic diagram illustrating a radio communication system, according to an example implementation of the present disclosure. In FIG. 1, the radio communication system 100 includes the terminal devices 101A to 101C and the base station device 103 (BS 103). The terms base station device, base station, and BS herein may be used interchangeably. The terms terminal device, user equipment, and UE herein may be used interchangeably.

BS 103 may include one or more transmission/reception devices. When BS 103 may be configured of multiple transmission/reception devices, each of the multiple transmission/reception devices may be arranged at a different position. A transmission/reception device may include a transmission device and/or a reception device.

BS 103 may serve radio communication and provide one or more cells. A cell is defined as a set of resources used for a wireless communication. A cell may include one or both of a downlink component carrier and an uplink component carrier. A serving cell may include a downlink component carrier and two or more uplink component carriers.

Some embodiments define the behavior of the UE (e.g., the MAC entity in the UEs 101A-101C) when the TCI states of multiple future time instances are indicated by the BS 103 to the UE 101A-101C. The TCI states of several future time instances may be indicated to the UE using a single indication. Two UE behavior are described by the present embodiments. The first behavior describes handling of the predictive beam configurations. The second behavior describes measuring the quality of the beams that are associated with predictive TCI states.

### UE Behavior for Handling Predictive Beam Configurations

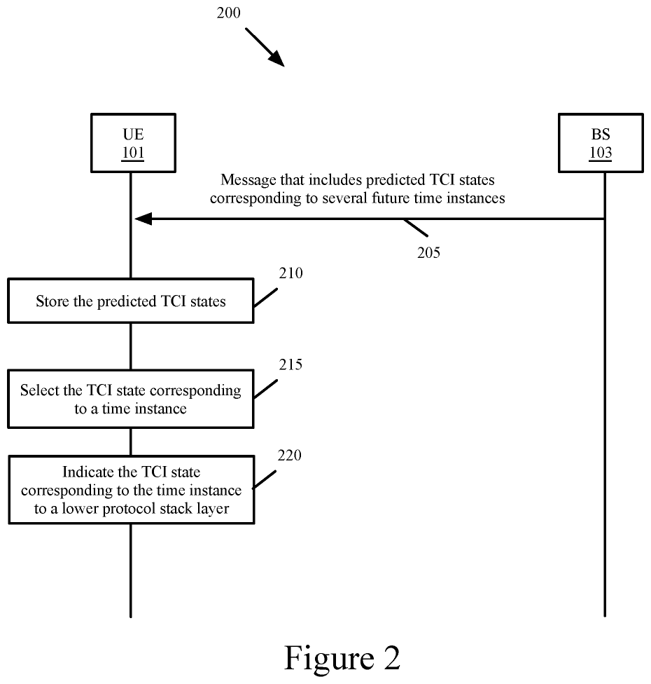

FIG. 2 is a sequence diagram 200 illustrating an example message flow for handling predictive beam configurations, according to an example implementation of the present disclosure. With reference to FIG. 2, the UE 101 may be any of the UEs 101A-101C shown in FIG. 1.

In step 205, the UE 101 may receive, from the BS 103, a message that may include predicted TCI states that correspond to several future time instances. A time instance may be a TTI, a slot, a time duration, a time instant, etc. The BS 103 may indicate or pre-configure the UE 101 with predicted TCI state as a list, as a single parameter, or as a table/matrix. The term pre-configuration indicates that, in the beam management of the present embodiments, the BS may provide the TCI state for a beam to the UE prior to the beam is detected by the UE. In addition, in the beam management of the present embodiments, the BS 103 may provide the TCI states for several future beams to the UE 101. In contrast, the prior art beam management provides the TCI state for a beam, only after the UE detects and reports the beam detection to the BS.

The UE 101, in some embodiments, may receive the predicted TCI state information of future time instances from the BS 103 in one or more messages, such as Layer 1 (L1), Layer 2 (L2), or Layer 3 (L3) messages. Each message may include several TCI states. For clarity, only one such message is shown in FIG. 2.

In some embodiments, the BS 103 may pre-configure the UE 101 by using, for example, a new or enhanced message, such as, a new/enhanced MAC CE. It should be noted that term enhanced refers to modification to the existing 3GPP message structure to carry additional information related, e.g., to the TCI state(s) of the predicted beam (e.g., by adding additional fields). Other L1/L2/L3 messages, an activation command that is similar to MAC CE, an RRC, or any higher layer messages may also be used to transmit this information (or configuration) to the UE. The pre-configuration may also include the predicted slot numbers and/or TTIs.

The UE 101 may store (as shown in block 210) the predicted TCI state information. At the occurrence of each time instance (e.g., a time instance in present or future), the UE 101 may select (as shown in block 215) the TCI state ID or indices that corresponds to the time instance for activation or deactivation. The UE 101 may select the TCI state ID or indices, for example, based on the time instance, the TCI beam prediction configuration, and/or the actual beam measurements.

The UE (e.g., the MAC entity in the UE) may indicate (as shown in block 220) the predicted TCI state ID or information to a lower protocol stack layer of the UE. For example, the MAC entity of the UE 101 may indicate the predicted TCI state ID corresponding to the time instance to the physical protocol stack layer of the UE 101.

This following example further explains the embodiment of FIG. 2. The BS (e.g., gNB) may indicate one or more predicted TCI states that are associated with the predicted beam(s) for future time instances. For example, the BS may indicate TCI state information for TTI a and TCI state information for TTI b. The UE may store this information for future reference.

At the start of TTI a, the MAC entity of the UE may indicate the TCI state ID and/or information for TTI a to the lower layer. At the start of TTI b, the MAC entity of the UE may indicate the TCI state ID and/or information for TTI b to the lower layer, and so on. This may be done with or without another explicit MAC CE message from the BS for the associated beam in the future time instance. The UE may then start receiving the DL signal (e.g., the PDSCH) by applying the predicted TCI state information of the corresponding beam. The beam maybe set A, set B, or a combination of set A and set B.

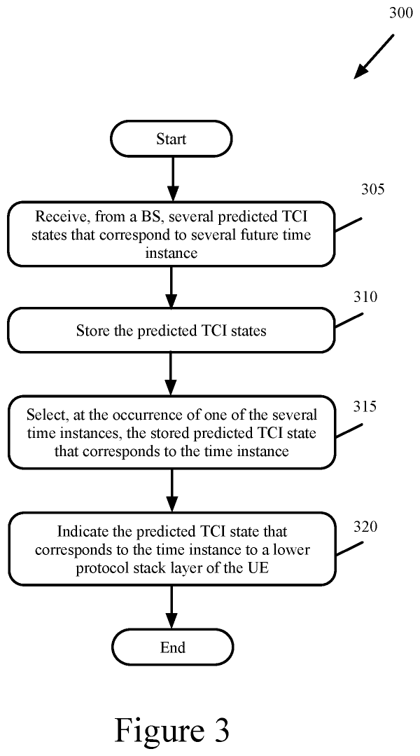

FIG. 3 is a flowchart illustrating an example method/process 300 performed by a UE for handling predictive beam configurations, according to an example implementation of the present disclosure. With reference to FIG. 3, the process 300 may be performed by at least one processor of a UE 101A-101C, shown in FIG. 1.

The process 300 may receive (at block 305), from a BS, several predicted TCI states that correspond to several future time instances. For example, the UE may receive the predicted TCI states through RRC signaling, DCI, MAC CE, etc. Each predicted TCI state may represent a specific beam configuration. The predicted TCI states may be generated by either the BS or the UE using one or more AI/ML mechanisms.

The process 300 may store (at block 310) the predicted TCI states. At the occurrence of one of the several time instances, the process 300 may select (at block 315) the stored predicted TCI state that corresponds to the time instance. The time instance may be, for example, a time instant, a TTI, a slot, or a duration of time.

The process 300 may indicate (at block 320) the predicted TCI state that corresponds to the time instance to a lower protocol stack layer of the UE. For example, the process 300 may indicate the predicted TCI state that corresponds to the time instance to a physical protocol stack layer of the UE. The process 300 may then end.

In some embodiments, the process 300 may receive DL data from the BS using one or more resources that are identified by the predicted TCI state indicated to the physical protocol layer. The DL data may be, for example, a PDCCH or a PDSCH.

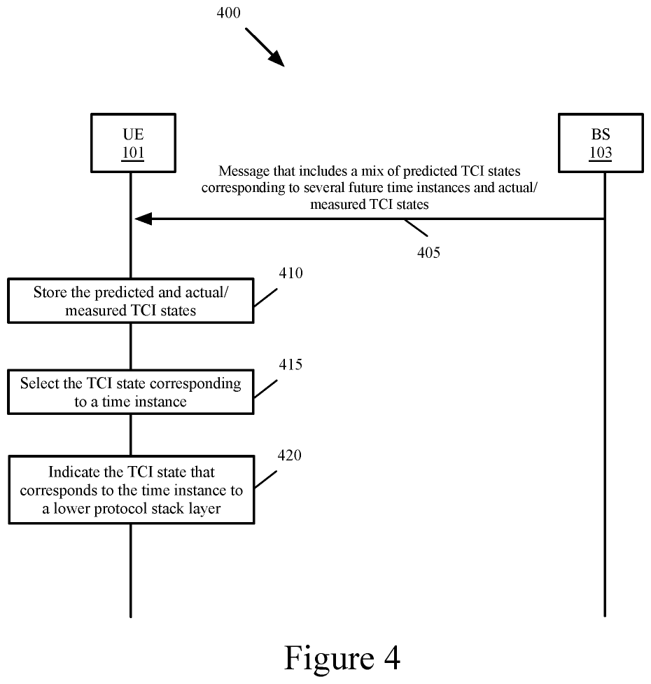

FIG. 4 is a sequence diagram 400 illustrating an example message flow for handling a mix of predictive beam configurations and actual/measured beam configurations, according to an example implementation of the present disclosure. With reference to FIG. 4, the UE 101 may be any of the UEs 101A-101C shown in FIG. 1.

In step 405, the UE 101 may receive, from the BS 103, a message that may include a mix of predicted TCI states that correspond to several future time instances and actual/measured TCI states. The message may identify each TCI state as a predicted TCI state or an actual/measured TCI state.

The UE 101, in some embodiments, may receive the predicted TCI state information of future time instances from the BS 103 in one or more messages, such as L1, L2, or L3 messages. Each message may include a mix of several predicted and actual/measured TCI states. For clarity, only one such message is shown in FIG. 4.

The UE 101 may store (as shown in block 410) the predicted and the actual/measured TCI state information. At the occurrence of each time instance, the UE 101 may select (as shown in block 415) the TCI state ID or indices corresponding to the time instance for activation or deactivation. The UE 101 may select the TCI state ID or indices, for example, based on the time instance, the TCI beam prediction configuration, and/or the actual beam measurements.

The UE (e.g., the MAC entity in the UE) may indicate (as shown in block 420) the TCI state ID or information that corresponds to the time instance to the lower protocol stack layer of the UE. For example, the MAC entity of the UE 101 may indicate the TCI state ID corresponding to the time instance to physical protocol stack layer of the UE 101.

The TCI states may be used to specify precoding or beamforming configurations that the UE may utilize during DL transmission. These states may be managed by the BS. In some implementations, a maximum of 8 activated TCI states may be mapped to a list of codepoints. The BS may indicate one of the activated TCI states for a PDSCH via the TCI field included in a DCI format 11, which is used for scheduling the PDSCH. Each of the activated TCI states may represent a specific precoding or beamforming configuration. These activated TCI states may then be mapped to a list of codepoints, which serve as reference indices for identifying the TCI states during scheduling.

The UE's MAC entity, in some embodiments, may activate or deactivate a mix of predicted (e.g., beam indication/TCI state information for future time instances) and actual/measured TCI states within the 8 TCI states. For example, the UE may activate 3 predicted TCI states and 5 actual/measured TCI states. The UE may activate all predicted TCI states, all actual/measured TCI states, or any combination of the predicted and actual/measured TCI states.

In some embodiments, activation of up to 8 TCI state may be extended to incorporate the activation or deactivation of one or more future/predicted TCI states (e.g., the TCI states of future time instances) by the UE's MAC entity.

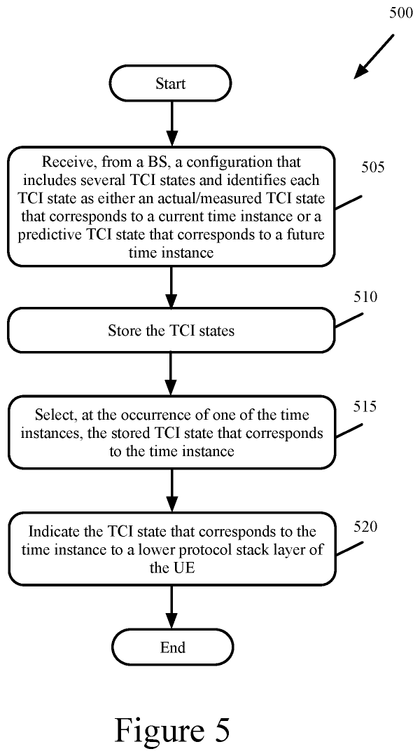

FIG. 5 is a flowchart illustrating an example method/process 500 performed by a UE for handling a mix of predictive and actual/measured beam configurations, according to an example implementation of the present disclosure. With reference to FIG. 5, the process 500 may be performed by at least one processor of a UE 101A-101C, shown in FIG. 1.

The process 500 may receive (at block 505), from a BS, a configuration that includes several TCI states and identifies each TCI state as either a measured TCI state that corresponds to a current time instance or a predictive TCI state that corresponds to a future time instance. For example, the UE may receive the predicted TCI states through RRC signaling, DCI, MAC CE, etc. Each TCI state may represent a specific beam configuration. The predicted TCI states may be generated by either the BS or the UE using one or more AI/ML mechanisms.

The process 500 may store (at block 510) the TCI states. At the occurrence of one of the time instances, the process 500 may select (at block 515) the stored TCI state that corresponds to the time instance. The time instance may be, for example, a time instant, a TTI, a slot, or a duration of time. The TCI state that corresponds to the time instance may be either a predictive TCI state or an actual/measured TCI state.

The process 500 may indicate (at block 520) the TCI state that corresponds to the time instance to a lower protocol stack layer of the UE. For example, the process 500 may indicate the TCI state that corresponds to the time instance to a physical protocol stack layer of the UE. The process 500 may then end.

In some embodiments, the process 500 may receive DL data from the BS using one or more resources that are identified by the predicted TCI state indicated to the physical protocol layer. The DL data may be, for example, a PDCCH or a PDSCH.

UE Behavior for Measuring the Quality of the Beams that are Associated with Predictive Beam Configurations

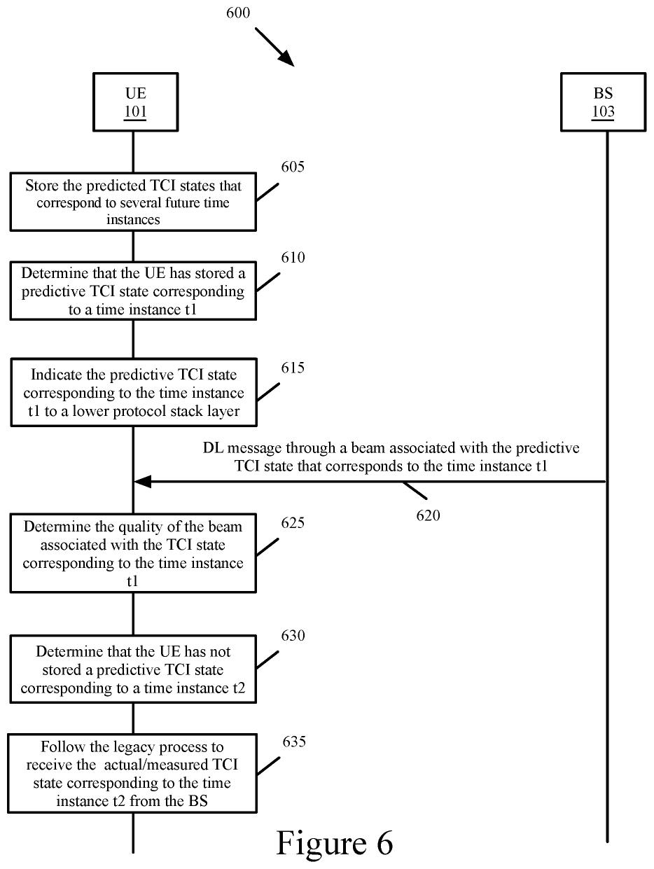

FIG. 6 is a sequence diagram 600 illustrating an example message flow for measuring the quality of beams that are associated with predictive beam configurations, according to an example implementation of the present disclosure. With reference to FIG. 6, the UE 101 may be any of the UEs 101A-101C shown in FIG. 1.

In step 601, the UE 101 may store the predicted TCI state information of future time instances provided by the BS 103 in one or more messages. For example, the TCI state information may be provided by the BS 103 to the UE 101 through one or more L1, L2, and/or L3 messages, as described above with reference to FIG. 2.

The MAC entity at each time instance may identify, or distinguish between, the actual/measured TCI state indices and information and the predicted TCI state indices and information. For example, the UE 101 may check whether the UE has the predicted TCI state information of a detected beam (e.g., received earlier in a MAC CE, an RRC, or a similar message as a predicted TCI state configuration for a predicted beam) or the UE does not have the TCI information and has to follow the legacy behaviour.

In some embodiments, the BS may configure different sets (e.g., pools) of TCI state indices, information, and/or configuration. The BS may configure one set/pool of TCI state indices as the predicted TCI state indices (e.g., for the predicted beam(s)) for future TTIs and another set/pool of TCI state indices for the actual TTI and the actual beam (e.g., the measured beam).

The sets/pools of TCI state indices, information, and/or configuration, in some embodiments, may include a legacy beam indication pool and a beam prediction pool. The legacy beam indication pool may include the TCI states that are used for traditional beam indication purposes. These TCI states may inform the UE about beamforming parameters that are determined based on the existing conditions, without any prediction involved. For example, the BS may use these TCI states to indicate beams based on the current channel conditions or based on pre-defined beamforming patterns.

The beam prediction pool may include the TCI states that are specifically designed for the temporal beam prediction. These TCI states may be based on the predictive algorithms or models that anticipate future channel conditions and beamforming requirements. The BS may calculate these predicted TCI states based on factors, such as, historical channel data, mobility patterns, or machine learning algorithms trained on past behavior, etc.

In step 610, the UE 101 may determine that the UE has stored a predictive TCI state corresponding to a time instance, such as time instance t1. For example, the UE 101 may determine whether the UE has earlier received the predictive TCI state corresponding to the time instance t1 in a MAC CE, RRC or a similar message as a predicted TCI state configuration.

The UE 101 may indicate (as shown in block 615) the predictive TCI state corresponding to the time instance t1 to a lower protocol stack layer. For example, the MAC entity of the UE 101 may indicate the predicted TCI state ID corresponding to the time instance t1 to the physical protocol stack layer of the UE 101. The UE 101 may receive (as shown in step 620) a DL message from the BS 103 through a beam associated with the predictive TCI state that corresponds to the time instance t1.

At each TTI or time instance, the UE (e.g., the MAC entity of the UE) may check if there are any additional triggers configured by the BS 103. For example, the BS 103 may configure L1-RSRP thresholds (or thresholds with other similar parameters) to compare and measure the L1-RSRP of one or more actual/measured or detected beam and its associated TCI index to the predicted TCI index (indices) of the predicted beam. In another example the UE may compare the L1-RSRP and/or TCI state information of one or more past beam(s) to one or more predicted TCI state information that may be applicable to the current TTI and the detected beam.

In the embodiment of FIG. 6, the BS 103 may only transmit (as shown in step 620) a DL message (e.g., a PDSCH or a similar message) using the predicted TCI state information and no other reference signals (RSs) may be transmitted. At the time instance t1, the UE 103 may receive the PDSCH using the predicted TCI state information provided by the BS 103 in the past (e.g., in a (pre) configuration). It should be noted that the UE or the BS may activate the TCI state before or after the transmission of the signal (e.g., the PDSCH).

Upon receiving PDSCH or a similar message, the UE may determine (as shown in block 625) the quality of the beam that is associated with the TCI state corresponding to the time instance t1. The UE 101 may optionally report to the BS if the PDSCH quality is not up to a desired (e.g., (pre) configured) threshold value or range. For example, the UE 101 may report to the BS if the L1-RSRP of the beam is not above a (pre) configured threshold.

In addition to, or in lieu of measuring the L1-RSRP, some embodiments may measure other parameters, such as RSSI, SINR, SNR, or CQI and may compare the value of one or more of these parameters with the corresponding (pre) configured thresholds to determine the quality of the beam associated with the TCI state.

The BS, in some embodiments, may configure the UE to activate or deactivate the predicted beam TCI state after a certain delay or pre-emptively activate or deactivate predicted beam TCI state based on one or more (pre) configured conditions or thresholds. This ensures that the UE switches to the predicted beams at the appropriate time to optimize performance.

The configured L1-RSRP threshold is the threshold below or above which the UE may follow a certain behavior as pre-configured by the BS. For example, the UE may switch to a new beam, may apply new TCI state information, may keep using the current beam or current TCI state information, or may send an indication or report to the network, etc. Based on the comparison between actual/measured and predicted beam information (e.g., the TCI state information, the beam ID, etc.) the BS may indicate or (pre) configure UE to apply (or not apply) the predicted TCI index if the L1-RSRP is above (or below) the configured threshold.

Upon receiving the PDSCH or similar message, the UE may report to the network if the PDSCH quality is not up to the desired (e.g., (pre) configured) threshold value or a range. For example, the UE may report to the network if the L1-RSRP is not be above a certain (pre) configured threshold. The UE, in some embodiments, may implicitly report. For example, the UE may only indicate when the desired signal quality is above or below a (pre) configured threshold. For example, if no indication is sent, the BS may assume that the signal quality is either good (or bad) or the signal is above (or below) a threshold.

The BS may also indicate or (pre) configure the UE to periodically, or upon request, or based on one or more triggers (e.g., a threshold) send a report to the network regarding the measured beam quality, the corresponding TCI state, and the predicted beam TCI state that is pre-configured by the network. These reports may include information such as the measured signal strength, the beam index, the TCI state, and/or any other relevant parameters of measured beam and predicted beam.

In some embodiments, if the UE selects a specific action (e.g., the UE switches to a new beam, applies a new TCI state information, keeps using the current beam or current TCI state information, or sends an indication or report to the BS etc.), the UE may indicate the action to the BS.

In step 630, the UE 101 may determine that the UE has not stored a predictive TCI state corresponding to a time instance, such as the time instance t2 (e.g., the current time instance). The UE 101 may follow (as shown in block 635) the legacy process to receive the actual/measured TCI state the corresponding to the time instance t2 from the BS 103. For example, the UE 101 may scan a slot and may detect a beam. The UE 101 may report the beam (e.g., the CSI-RS of the beam) to the BS 103. After receiving the report that the UE 101 has detected the beam associated with the reported CSI-RS, the BS may send a message (e.g., a MAC CE) that includes a TCI state. The BS 103 may then send a DCI message with the TCI state index that is pointing to the reported CSI-RS. It should be noted that the TCI state index may be considered as an identifier of the TCI state, which is pointing to the TCI state. The BS 103 may then transmit the PDSCH using the provided TCI state configuration.

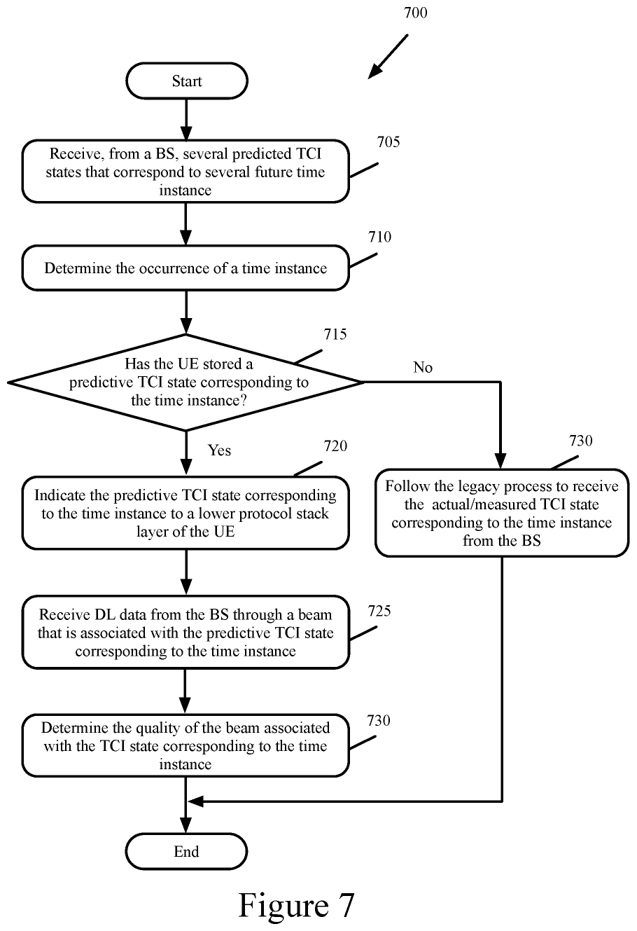

FIG. 7 is a flowchart illustrating an example method/process 700 performed by a UE for measuring the quality of beams that are associated with predictive beam configurations, according to an example implementation of the present disclosure. With reference to FIG. 7, the process 700 may be performed by at least one processor of a UE 101A-101C, shown in FIG. 1.

The process 700 may receive (at block 705), from a BS, several predicted TCI states that correspond to several future time instances. For example, the UE may receive the predicted TCI states through RRC signaling, DCI, MAC CE, etc. Each predicted TCI state may represent a specific beam configuration. The predicted TCI states may be generated by either the BS or the UE using one or more AI/ML mechanisms.

The process 700 may determine (at block 710) the occurrence of a time instance. For example, the time instance may be a TTI, a slot, etc. The process 700 may make a determination (at block 715) as to whether the UE has stored a predictive state corresponding to the time instance. If a determination is made (at block 715) that the UE has not stored a predictive state corresponding to the time instance, the process 700 may follow (at block 730) the legacy process to receive the actual/measured TCI state corresponding to the time instance from the BS. For example, the process 700 may follow the process described with reference to block 635 of FIG. 6. The process 700 may then end.

If a determination is made (at block 715) that the UE has stored a predictive state corresponding to the time instance, the process 700 may indicate (at block 720) the predictive TCI state corresponding to the time instance to a lower protocol stack layer of the UE. For example, the process 700 may indicate the predicted TCI state that corresponds to the time instance to a physical protocol stack layer of the UE.

The process 700 may then receive (at block 725) DL data from the BS through a beam that is associated with the predictive TCI state corresponding to the time instance. The DL data may be, for example, a PDCCH, a PDSCH, or a similar message.

The process 700 may determine (at block 730) the quality of the beam associated with the TCI state corresponding to the time instance. The process 700 may then end.

In some embodiments, determining the quality of beam associated with the predictive TCI state corresponding to the time instance may include measuring the value of a parameter associated with the quality of the beam and comparing the value of the parameter with a threshold. The parameter may, for example, be the L1-RSRP of the beam.

In some embodiments, determining the quality of beam associated with the predictive TCI state corresponding to the time instance may include comparing the quality of the beam with the quality of the one or more beams received from the BS at one or more time instances other that the current time instance. In some embodiments, determining the quality of beam associated with the predictive TCI state corresponding to the time instance may include comparing the quality of the first beam with the quality of a second beam that the UE has received from the BS.

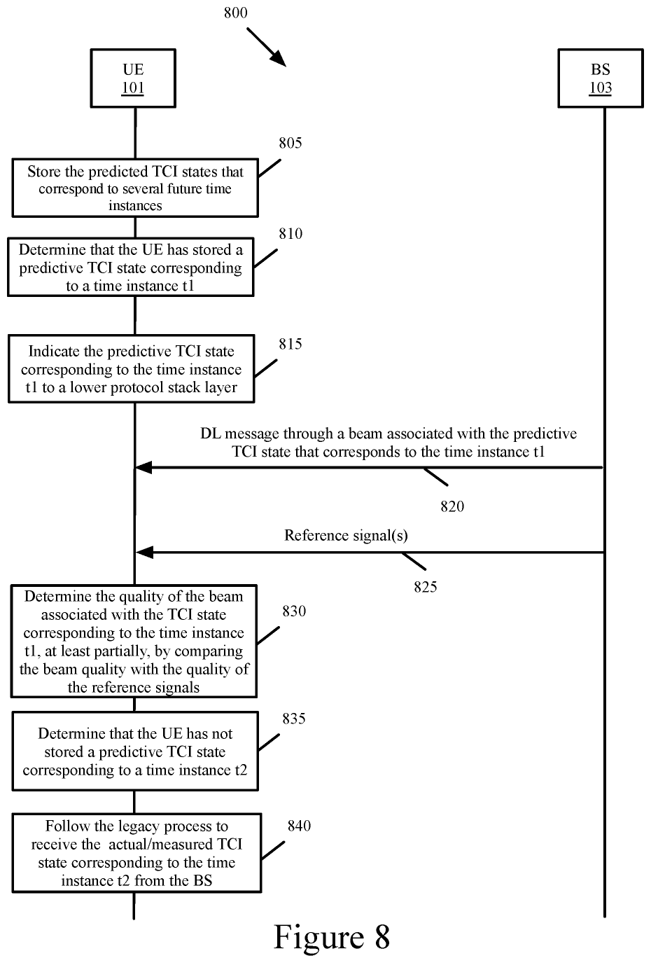

FIG. 8 is a sequence diagram 800 illustrating an example message flow for measuring the quality of beams that are associated with predictive beam configurations, according to an example implementation of the present disclosure. With reference to FIG. 8, the UE 101 may be any of the UEs 101A-101C shown in FIG. 1. The operations performed by the blocks 805-815 and the step 820 of FIG. 8 are similar to the operations performed by the blocks 605-615 and the step 620 of FIG. 6, respectively.

At each TTI or time instance, the UE (e.g., the MAC entity of the UE) may check if there are any additional triggers configured by the BS 103. For example, the BS 103 may configure L1-RSRP thresholds (or thresholds with other similar parameters) to compare and measure the L1-RSRP of one or more actual/measured or detected beam or reference signal and its associated TCI index to the predicted TCI index (indices) of the predicted beam. In another example the UE may compare the L1-RSRP and/or TCI state information of one or more past beam(s) to one or more predicted TCI state information that may be applicable to the current TTI and the detected beam.

In the embodiment of FIG. 8, the BS 103 may transmit (as shown in step 825) one or more reference signals to the UE 101. The reference signals may, for example, be SSBs, CSI-RSs, SRSs, DMRSs, RSRPs, and/or PTRSs. It should be noted that the UE or the BS may activate the TCI state before or after the transmission of the signal(s) (PDSCH, SSB/CSI-RS etc.)

Upon receiving PDSCH or a similar message, the UE may determine (as shown in block 830) the quality of the beam that is associated with the TCI state corresponding to the time instance t1, at least partially, by comparing the beam quality with the quality of the reference signals.

The UE 101 may optionally report to the BS if the PDSCH quality is not up to a desired (e.g., (pre) configured) threshold value or range. For example, the UE 101 may report to the BS if the L1-RSRP of the beam is not above a (pre) configured threshold.

The BS, in some embodiments, may configure the UE to activate or deactivate the predicted beam TCI state after a certain delay or pre-emptively activate or deactivate predicted beam TCI state based on one or more (pre) configured conditions or thresholds. This ensures that the UE switches to the predicted beams at the appropriate time to optimize performance.

The configured L1-RSRP threshold is the threshold below or above which the UE may follow a certain behavior as pre-configured by the BS. For example, the UE may switch to a new beam, may apply new TCI state information, may keep using the current beam or current TCI state information, or may send an indication or report to the network, etc. Based on the comparison between actual/measured and predicted beam information (e.g., the TCI state information, the beam ID, etc.) the BS may indicate or (pre) configure UE to apply (or not apply) the predicted TCI index if the L1-RSRP is above (or below) the configured threshold.

Upon receiving the PDSCH or similar message, the UE may report to the network if the PDSCH quality is not up to the desired (e.g., (pre) configured) threshold value or a range. For example, the UE may report to the network if the L1-RSRP is not be above a certain (pre) configured threshold. The UE, in some embodiments, may implicitly report. For example, the UE may only indicate when the desired signal quality is above or below a (pre) configured threshold. For example, if no indication is sent, the BS may assume that the signal quality is either good (or bad) or the signal is above (or below) a threshold.

In addition to, or in lieu of measuring the L1-RSRP, some embodiments may measure other parameters, such as received signal strength indicator (RSSI), signal to interference plus noise ratio (SINR), signal to noise ratio (SNR), or channel quality indicator (CQI) and may compare the value of one or more of these parameters with the corresponding (pre) configured thresholds to determine the quality of the beam associated with the TCI state. It should be noted that the UE may identify different beams by their corresponding IDs.

The BS may also indicate or (pre) configure the UE to periodically, or upon request, or based on one or more triggers (e.g., a threshold) send a report to the network regarding the measured beam quality, the corresponding TCI state, and the predicted beam TCI state that is pre-configured by the network. These reports may include information such as the measured signal strength, the beam index, the TCI state, and/or any other relevant parameters of measured beam and predicted beam.

In some embodiments, if the UE selects a specific action (e.g., the UE switches to a new beam, applies a new TCI state information, keeps using the current beam or current TCI state information, or sends an indication or report to the BS etc.), the UE may indicate the action to the BS. The operations performed by the blocks 835-840 of FIG. 8 are similar to the operations performed by the blocks 630-635 of FIG. 6, respectively.

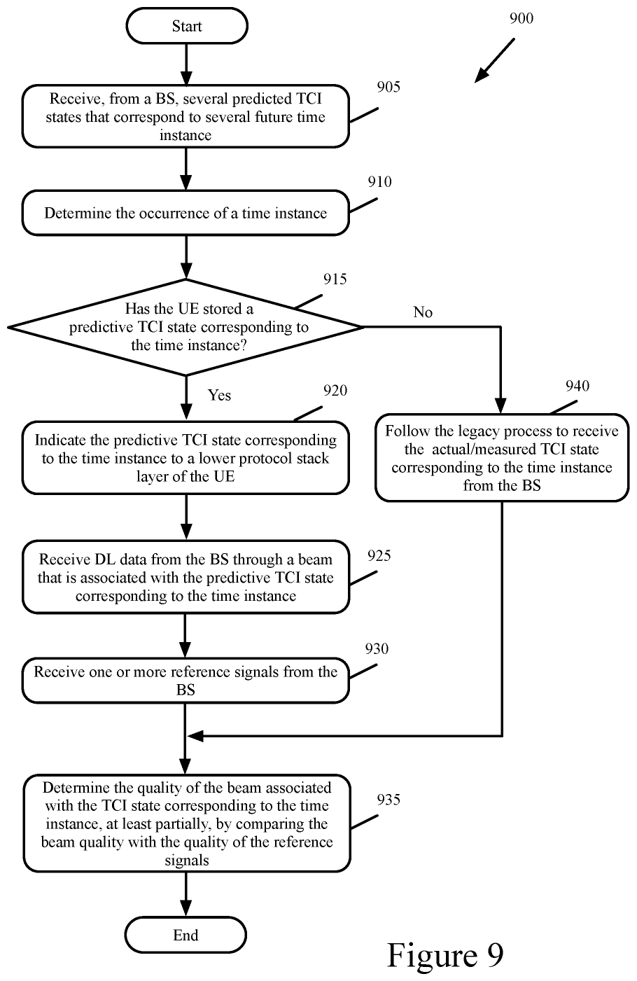

FIG. 9 is a flowchart illustrating an example method/process 900 performed by a UE for measuring the quality of beams that are associated with predictive beam configurations based on the quality of one or more reference beams, according to an example implementation of the present disclosure. With reference to FIG. 9, the process 900 may be performed by at least one processor of a UE 101A-101C, shown in FIG. 1. The operations performed by the blocks 905-925 and 940 of FIG. 9 are similar to the operations performed by the blocks 705-725 and 735 of FIG. 7, respectively.

The process 900 may receive (at block 930) one or more reference signals from the BS. The reference signals may, for example, be SSBs, CSI-RSs, SRSs, DMRSs, RSRPs, and/or PTRSs. The process 900 may determine (at block 935) the quality of the beam associated with the TCI state corresponding to the time instance, at least partially by comparing the beam quality with the quality of the reference signals. For example, the process 900 may determine the quality of the reference signal(s) and may compare the quality of the beam associated with the predictive TCI state corresponding to the time instance with the quality of the one or more reference signals. The process 900 may then end.

In some embodiments, determining the quality of beam associated with the predictive TCI state corresponding to the time instance may include measuring the value of a parameter associated with the quality of the beam and comparing the value of the parameter with a threshold. The parameter may, for example, be the L1-RSRP of the beam.

In some embodiments, determining the quality of beam associated with the predictive TCI state corresponding to the time instance may include comparing the quality of the beam with the quality of the one or more beams received from the BS at one or more time instances other that the current time instance. In some embodiments, determining the quality of beam associated with the predictive TCI state corresponding to the time instance may include comparing the quality of the first beam with the quality of a second beam that the UE has received from the BS.

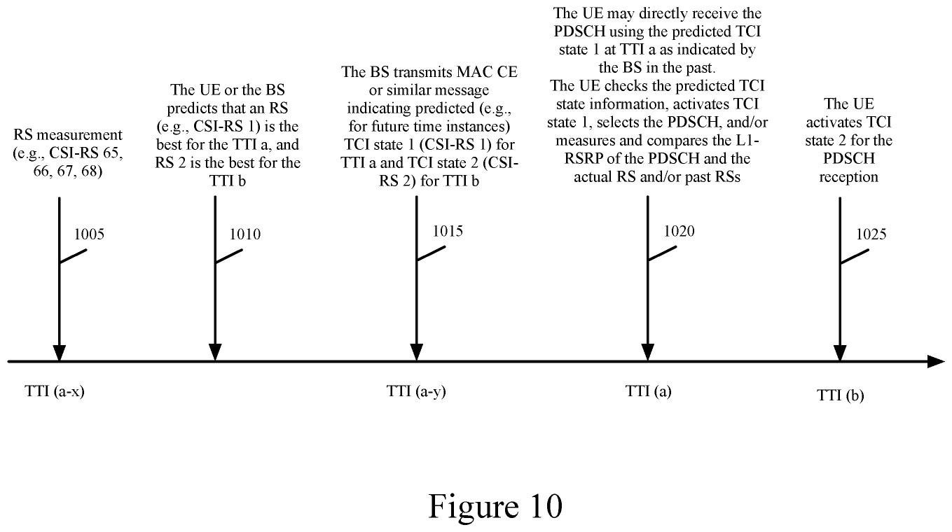

FIG. 10 is a timing diagram illustrating an example representation of the UE and the BS interactions, according to an example implementation of the present disclosure. With reference to FIG. 10, at step 1005 at TTI (a-x), the UE or the BS may perform RS measurements and may collect data for beam prediction. For example, the UE or the BS may collect report for CSI-RS 65, 66, 67, 68, etc. The RS measurements may be performed using periodic or aperiodic CSI reporting procedures.

Based on the collected measurements, the AI/ML model at the UE or the BS may predict the beam and TCI state for future time instances (at step 1010). For example, an RS (e.g., CSI-RS 1) may be predicted to be the best for TTI a, and RS 2 may be predicted to be the best for TTI b.

The predicted beam and TCI state information for future time instances, for example, TTI a (TCI state 1) (CSI-RS 1), TTI b (TCI State 2) (CSI-RS 2), TTI c (TCI State 3) (CSI-RS 2) etc., may be provided (at step 1015) to the UE in a message like MAC CE or RRC or a similar message by the gNB to the UE in TTI (a-y).

Upon receiving predicted beam and TCI state information, the UE may store the information to be used in the future time instances. This information may be stored, for example, in the UE's MAC entity. At the future time instance for e.g., at TTI a, the UE may perform the following functions at step 1020. In a first option, the BS may only transmit the PDSCH using the predicted TCI state information and no other reference signals (RS) are transmitted. In this option, at the TTI a, the UE may receive the PDSCH using the predicted TCI state information provided by the BS in a (pre) configuration. Upon receiving the PDSCH or a similar message, the UE may report to the BS if the PDSCH quality is not up to the desired (pre) configured threshold value or a range (e.g., if the L1-RSRP is not above a certain (pre) configured threshold). The UE may report implicitly, for example, by only indicating when the desired signal quality is above or below a (pre) configured threshold. For example, if no indication is sent, the BS may assume that the signal quality is good/bad, is above/below a threshold, and no explicit indication may be sent to the BS).

In a second option, the BS may transmit the PDSCH using the predicted TCI state and the BS may also transmit one or more other RSs (e.g. set of SSBs/CSI-RS). Therefore, in this option, the UE may measure the L1-RSRP of reference signals (e.g., the set of SSB/CSI-RS) transmitted by the BS in addition to the PDSCH. For example, the UE may measure the L1-RSRP of actual/measured CSI-RS 1 and CSI-RS 2 and then may compare it to the TCI state 1 (CSI-RS-1) provided as a predicted TCI state by the BS for receiving the PDSCH. Following this the UE may follow the behavior as described above as per the threshold values and configuration provided by the network. At TTI (b) step 1015, the UE may activate TCI state 2 for the PDSCH reception.

In some embodiments, the BS may transmit only the RS associated with the predicted beam TCI state. For example, the BS may transmit CSI-RS 1 (TCI state 1). Then UE may compare the predicted TCI and the measured TCI state information for the CSI-RS 1 and receive the PDSCH using either predicted TCI state information, may request a different TCI state information from the BS, or may use a previously configured TCI state information. In other embodiments, the BS may configure the UE with a default TCI state for generic/common scenarios having certain L1-RSRP value or range.

The UE 101 may compare various combinations of one or multiple values of the L1-RSRP or similar parameters, the actual/measured TCI state information, one or more predicted TCI state information, the predicted L1-RSRP of same or different PDSCH, and/or one or more reference signals.

The UE may compare various combination of one or multiple beam parameter values of, for example, the L1-RSRP or similar parameters, the actual/measured TCI state information, one or more predicted TCI state information, and/or the predicted L1-RSRP of same or different PDSCH. The comparison between one or multiple beam parameters to each other or to a threshold may be done at the same or different time instances (one or multiple) or TTIs respectively. In some embodiments, the related beam parameter values may also be compared to a pre-determined threshold.

In some embodiments, the BS may provide the predicted beam information/TCI state of either consecutive TTIs/time instances or non-consecutive TTIs/time instances. The UE may check if the predicted beam information/TCI state is for consecutive TTIs or non-consecutive TTIs and may map (e.g., associate) it with the current TTI and the corresponding beam measurements.

The BS, in some embodiments, may include flags or indicators to distinguish between the TCI states that are based on the actual measurements and the TCI states that are based on prediction. This allows the UE to differentiate between the TCI states that are derived from the real-time data and the TCI states that are derived from the predictive models.

Initially, the UE may not have the best beamforming information because the TCI state is unknown. Therefore, some embodiments may consider the following options. In some embodiments, the BS may configure the UE to activate or deactivate the predicted beam TCI state after a certain delay based on one or more (pre) configured conditions. This may be done using a (pre) configured timer. For example, if the L1-RSRP of the actual/measured beam in each time instance is at or above a threshold or a threshold range, the UE may start the timer. As soon as the actual/measured L1-RSRP drops below the threshold, the UE may apply the predicted TCI state information provided by the BS earlier for the given time instance. If the L1-RSRP of the actual/measured beam does not drop below the threshold and the timer expires, the UE may keep using the current TCI state and may not switch to the predicted or the new TCI state.

In some embodiments, the related parameter values of the actual/measured beam or the predicted beam may also be compared to a present, past, or future beam or related parameters. In some embodiments, the BS may switch to the predicted TCI state earlier (pre-emptively) if the measured/actual L1-RSRP of the beam falls below a threshold. For example, at TTI x if the measured/actual beam quality drops, the UE may start the timer and if the timer expires (e.g., the actual beam quality does not improve) the UE may pre-emptively switch to the predicted TCI state and may report this pre-emptive switch to the BS. The UE may report the actual/predicted beam or the TCI state switching delay to the BS, or the UE may store the information for several measurements and then report it either periodically or based on time, event or request based triggers. The delayed or pre-emptive activation or deactivation of the predicted beam TCI state(s) ensures that the UE switches to the predicted beams at the appropriate time to optimize performance.

Following this, for a given TTI/time instance in the future time instance, the MAC entity may indicate the predicted or applied/activated TCI state ID/information to the lower layer. The UE may start receiving the PDSCH or similar message via the selected beam. The beam may be set A or set B or a combination of set A/set B as specified in the standards.

In should be noted that in any of the above-mentioned processes, the message exchange between the network and the UE maybe implemented using for example, PHY/MAC/RRC messages, an L1/L2/L3 message, a new type of message, and/or a higher layer message.

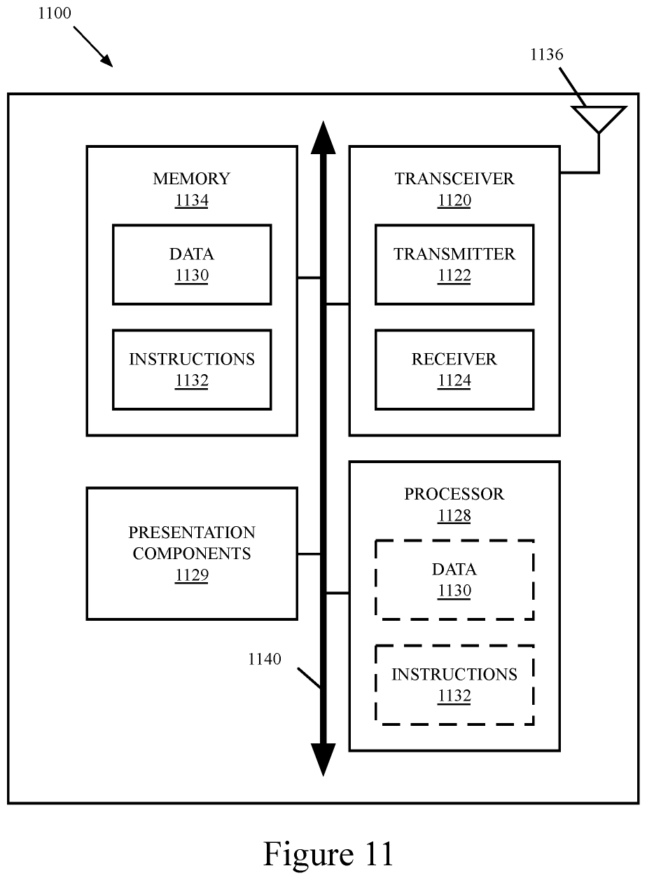

FIG. 11 is a block diagram illustrating a node 1100 for wireless communication, according to an example implementation of the present disclosure. As illustrated in FIG. 11, a node 1100 may include a transceiver 1120, a processor 1128, a memory 1134, one or more presentation components 1129, and at least one antenna 1136. The node 1100 may also include a radio frequency (RF) spectrum band module, a BS communications module, a network communications module, and a system communications management module, Input/Output (I/O) ports, I/O components, and a power supply (not illustrated in FIG. 11).

Each of the components may directly or indirectly communicate with each other over one or more buses 1140. The node 1100 may be a UE or a BS that performs various functions disclosed with reference to FIGS. 1 through 14.

The transceiver 1120 has a transmitter 1122 (e.g., transmitting/transmission circuitry) and a receiver 1124 (e.g., receiving/reception circuitry) and may be configured to transmit and/or receive time and/or frequency resource partitioning information. The transceiver 1120 may be configured to transmit in different types of subframes and slots including, but not limited to, usable, non-usable, and flexibly usable subframes and slot formats. The transceiver 1120 may be configured to receive data and control channels.

The node 1100 may include a variety of computer-readable media. Computer-readable media may be any available media that may be accessed by the node 1100 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

The memory 1134 may include computer-storage media in the form of volatile and/or non-volatile memory. The memory 1134 may be removable, non-removable, or a combination thereof. Example memory may include solid-state memory, hard drives, optical-disc drives, etc. As illustrated in FIG. 11, the memory 1134 may store a computer-readable and/or computer-executable instructions 1132 (e.g., software codes) that are configured to, when executed, cause the processor 1128 to perform various functions disclosed herein, for example, with reference to FIGS. 1 through 3. Alternatively, the instructions 1132 may not be directly executable by the processor 1128 but may be configured to cause the node 1100 (e.g., when compiled and executed) to perform various functions disclosed herein.

The processor 1128 (e.g., having processing circuitry) may include an intelligent hardware device, e.g., a Central Processing Unit (CPU), a microcontroller, an ASIC, etc. The processor 1128 may include memory. The processor 1128 may process the data 1130 and the instructions 1132 received from the memory 1134, and information transmitted and received via the transceiver 1120, the baseband communications module, and/or the network communications module. The processor 1128 may also process information to send to the transceiver 1120 for transmission via the antenna 1136 to the network communications module for transmission to a CN.

One or more presentation components 1129 may present data indications to a person or another device. Examples of presentation components 1129 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

The various foregoing example embodiments and modes may be utilized in conjunction with one another, e.g., in combination with one another.

Each of a program running on the BS and the terminal device according to an aspect of the present invention may be a program that controls a CPU and the like, such that the program causes a computer to operate in such a manner as to realize the functions of the above-described embodiment according to the present invention. The information handled in these devices is transitorily stored in a Random-Access-Memory (RAM) while being processed. Thereafter, the information is stored in various types of Read-Only-Memory (ROM) such as a Flash ROM and a Hard-Disk-Drive (HDD), and when necessary, is read by the CPU to be modified or rewritten.

It should be noted that the terminal device and the BS according to the above-described embodiment may be partially achieved by a computer. In this case, this configuration may be realized by recording a program for realizing such control functions on a computer-readable recording medium and causing a computer system to read the program recorded on the recording medium for execution.

It should be noted that it is assumed that the “computer system” mentioned here refers to a computer system built into the terminal device or the BS, and the computer system includes an OS and hardware components such as a peripheral device. Furthermore, the “computer-readable recording medium” refers to a portable medium such as a flexible disk, a magneto-optical disk, a ROM, a CD-ROM, and the like, and a storage device built into the computer system such as a hard disk.

Moreover, the “computer-readable recording medium” may include a medium that dynamically retains a program for a short period of time, such as a communication line that is used to transmit the program over a network such as the Internet or over a communication line such as a telephone line, and may also include a medium that retains a program for a fixed period of time, such as a volatile memory within the computer system for functioning as a server or a client in such a case. Furthermore, the program may be configured to realize some of the functions described above, and also may be configured to be capable of realizing the functions described above in combination with a program already recorded in the computer system.

Furthermore, the BS according to the above-described embodiment may be achieved as an aggregation (a device group) including multiple devices. Each of the devices configuring such a device group may include some or all of the functions or the functional blocks of the BS according to the above-described embodiment. The device group may include each general function or each functional block of the BS. Furthermore, the terminal device according to the above-described embodiment can also communicate with the base station device as the aggregation.

Furthermore, the BS according to the above-described embodiment may serve as an Evolved Universal Terrestrial Radio Access Network (E-UTRAN) and/or NG-RAN (Next Gen RAN, NR-RAN). Furthermore, the BS according to the above-described embodiment may have some or all of the functions of a node higher than an eNodeB or the gNB.

Furthermore, some or all portions of each of the terminal device and the base station device according to the above-described embodiment may be typically achieved as a large-scale integration (LSI) which is an integrated circuit or may be achieved as a chip set. The functional blocks of each of the terminal device and the BS may be individually achieved as a chip, or some or all of the functional blocks may be integrated into a chip. Furthermore, a circuit integration technique is not limited to the LSI, and may be realized with a dedicated circuit or a general-purpose processor. Furthermore, in a case that with advances in semiconductor technology, a circuit integration technology with which an LSI is replaced appears, it is also possible to use an integrated circuit based on the technology.

Furthermore, according to the above-described embodiment, the terminal device has been described as an example of a communication device, but the present invention is not limited to such a terminal device, and is applicable to a terminal device or a communication device of a fixed-type or a stationary-type electronic device installed indoors or outdoors, for example, such as an Audio-Video (AV) device, a kitchen device, a cleaning or washing machine, an air-conditioning device, office equipment, a vending machine, and other household devices.

The embodiments of the present invention have been described in detail above referring to the drawings, but the specific configuration is not limited to the embodiments and includes, for example, an amendment to a design that falls within the scope that does not depart from the gist of the present invention. Furthermore, various modifications are possible within the scope of one aspect of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

What is claimed is:

1. A user equipment (UE), comprising:
one or more non-transitory computer-readable media storing one or more computer-executable instructions for handling predictive transmission configuration indication (TCI) states; and
at least one processor coupled to the one or more non-transitory computer-readable media, and configured to execute the one or more computer-executable instructions to cause the UE to:
receive, from a base station (BS), a plurality of predicted TCI states, each predicted TCI state in the plurality of predicted TCI states corresponding to a future time instance in a plurality of time instances;
store the plurality of predicted TCI states;
select, at an occurrence of a time instance in the plurality of time instances, a predicted TCI state in the stored plurality of predicted TCI states that corresponds to the time instance; and
indicate the predicted TCI state corresponding to the time instance to a physical protocol stack layer of the UE.

2. The UE of claim 1, wherein receiving the plurality of predicted TCI states comprises receiving the plurality of predicted TCI states through one of radio resource control (RRC) signaling, downlink control information (DCI), or medium access (MAC) control element (CE).

3. The UE of claim 1, wherein the time instance comprises one of a time instant, a transmission time interval (TTI), a slot, or a duration of time.

4. The UE of claim 1, wherein the at least one processor is further configured to execute the one or more computer-executable instructions to cause the UE to:
receive downlink (DL) data from the BS using one or more resources identified by the predicted TCI state indicated to the physical protocol layer.

5. The UE of claim 4, wherein the DL data comprises one of a physical downlink control channel (PDCCH) or a physical downlink shared channel (PDSCH).

6. The UE of claim 1, wherein each predicted TCI state in the plurality of predicted TCI states represents a specific beam configuration.

7. The UE of claim 1, wherein the plurality of predicted TCI states is generated by one of the BS or the UE using one or more artificial intelligence/machine learning (AI/ML) mechanisms.

8. A user equipment (UE), comprising:
one or more non-transitory computer-readable media storing one or more computer-executable instructions for receiving a plurality of transmission configuration indication (TCI) states from a base station (BS); and
at least one processor coupled to the one or more non-transitory computer-readable media, and configured to execute the one or more computer-executable instructions to cause the UE to:
receive, from the BS, a configuration comprising a plurality of TCI states, the configuration identifying each TCI state as one of an actual TCI state corresponding to a current time instance in a plurality of time instances or a predictive TCI state corresponding to a future time instance in the plurality of time instances;
store the plurality of TCI states;
select, at an occurrence of a time instance in the plurality of time instances, a TCI state in the stored plurality of TCI states corresponding to the time instance; and
indicate the TCI state corresponding to the time instance to a physical protocol stack layer of the UE.

9. The UE of claim 8, wherein the TCI state corresponding to the time instance is a predictive TCI state.

10. The UE of claim 8, wherein the TCI state corresponding to the time instance is an actual TCI state.

11. The UE of claim 8, wherein the configuration further identifies each TCI state as an activated TCI state or a deactivated TCI state.

12. The UE of claim 8, wherein receiving the configuration comprises receiving the configuration through one of radio resource control (RRC) signaling, downlink control information (DCI), or medium access (MAC) control element (CE).

13. The UE of claim 8, wherein the at least one processor is further configured to execute the one or more computer-executable instructions to cause the UE to:
receive downlink (DL) data from the BS using one or more resources identified by the TCI state indicated to the physical protocol layer.

14. The UE of claim 8, wherein the plurality of predicted TCI states is generated by one of the BS or the UE using one or more artificial intelligence/machine learning (AI/ML) mechanisms.

15. A method of handling predictive transmission configuration indication (TCI) states, the method comprising:
receiving, from a base station (BS), a plurality of predicted TCI states, each predicted TCI state in the plurality of predicted TCI states corresponding to a future time instance in a plurality of time instances;
storing the plurality of predicted TCI states;
selecting, at an occurrence of a time instance in the plurality of time instances, a predicted TCI state in the stored plurality of predicted TCI states that corresponds to the time instance; and
indicating the predicted TCI state corresponding to the time instance to a physical protocol stack layer of the UE.
